(19) United States
(12) Patent Application Publication
(10) Pub. No.: US 2020/0130027 A1
(43) Pub. Date: Apr. 30, 2020

(54) Cleaning apparatus for mouse pad

(71) Applicant: Yudong Zhu, Wuhan City (CN)

(72) Inventor: Yudong Zhu, Wuhan City (CN)

(21) Appl. No.: 16/727,864

(22) Filed: Dec. 26, 2019

(30) Foreign Application Priority Data
Apr. 22, 2019 (CN) 2019103251432

(51) Int. Cl. B08B 7/04; B08B 1/00; B08B 1/04; B08B 3/08; G06F 3/039

(52) U.S. Cl. CPC B08B 7/04; B08B 1/001; G06F 3/039; B08B 3/08; B08B 1/04

(57) ABSTRACT

The invention discloses a cleaning apparatus for a mouse pad, which comprises a machine body. The machine body is provided with a slot with an opening facing upwards. A clip block is inserted into the slot. The clip block is provided with a clip slot. The upper side of the clamping groove is provided with a sliding groove, and a slide plate is slidably arranged in the sliding groove. The left and right ends of the slide plate are fixed with resetting components for resetting the slide plate. The upper end surface of the slide plate is provided with a pull rod. The invention is easy to operate, and the mouse pad is cleaned by soaking, scrubbing, washing, and drying processes. In this process, the degree of automation is high, manpower is saved, and the cleaning time is shortened. The mouse pad after cleaning can be used directly, which is convenient and convenient. Efficient.

### CROSS-REFERENCES TO RELATED APPLICATIONS

The present application claims priority from Chinese application No. 2019103251432 filed on Apr. 22, 2019 which is hereby incorporated by reference in its entirety.

### FIELD OF TECHNOLOGY

The invention relates to the technical field of packaging, and in particular relates to a cleaning apparatus for mouse pad.

### TECHNICAL FIELD

The existing mouse pad cleaning process is manual operation, which is time-consuming and has poor cleaning effect. Secondly, the cleaned mouse pad needs to be dried in the shade, which requires a long drying time, which brings inconvenience to the cleaning and use of the mouse pad. For this reason, it is necessary to design a device that can easily clean the mouse pad and improve its cleaning efficiency.

### Content of the Invention

An object of the present invention is to provide a cleaning device for a mouse pad, which is used to overcome the above defects in the prior art.

A cleaning device for a mouse pad according to the present invention includes a body, the body is provided with a slot with an opening facing upward, a clamping block is inserted into the slot, and a clamping slot is provided in the clamping block. A slide groove is communicated with the upper side of the clamping groove, and a slide plate is slidably arranged in the slide groove. The left and right ends of the slide plate are fixed with resetting components for resetting the slide plate. The upper end surface of the slide plate is provided with a pull rod. The upper side of the chute is provided with a communication slot, and the upper end of the pull rod is fixed with a fixed rod protruding from the front end into the outer space. A turning slot, a clamping rod is rotatably provided in the rotating slot, and the clamping rod is rotatably connected with the lower end of the rotating rod. Two sides of the slot are provided with an opening cavity, and the opening cavity is slidably provided with the clamping block. A fixed cavity is fixedly connected, and a sliding cavity is provided at the lower side of the open cavity. The lower end of the solid piece extends into the sliding cavity. A slider is fixed at one end of the solid block, and one side of the sliding cavity is provided. A meshing cavity is provided with a rotating gear in the meshing cavity through a transmission shaft for rotation, and the lower side of the slot is communicated with A cavity is provided with a rotating shaft for rotation in the cavity, and three fan blades are uniformly fixed on the upper end of the rotating shaft. A transmission device is provided on the left side of the cavity, and the transmission device is dynamically connected with the rotating shaft. A water tank is communicated with the lower side of the cavity, and a solenoid valve is fixed in the water tank. A contraction groove is provided on both sides of the cavity. The contraction groove is provided with a soft shaft to clean the surface of the mouse pad through a fixed shaft. A cleaning wheel, the cavity is provided with a cleaning device symmetrically on the left and right sides, and the cleaning device is respectively fixedly connected to the front and rear ends of the fixed shaft on the same side; the clamping rod is used to clamp the mouse pad, and the fixed block is passed through the fixed block The mouse pad is driven to rise, and the cleaning wheel is rotated to clean the mouse pad.

In a further technical solution, the transmission device includes a first bevel gear fixed at the front end of the transmission shaft on the left side, and a first bevel gear meshing with the first bevel gear is provided in the meshing cavity on the left side through the gear shaft to rotate. A two-bevel gear, the lower end of the gear shaft and the rotating shaft are connected by a toothed belt power; the first bevel gear drives the fan blades to rotate, stir the cleaning liquid in the cavity or generate a wind-drying mouse pad.

In a further technical solution, the cleaning device includes a pushing groove which is symmetrical back and forth and communicates with the shrinking groove. A pushing block is slidably arranged in the pushing groove, and a guide block is fixed on the rear end surface of the pushing block. A slot is provided in the slot. A meshing gear is provided in the slot by rotating through a shaft. A power device is arranged between the pushing slots. The power device is meshed with the meshing gear. There is a transmission cavity. One end of the coupling shaft extends into the transmission cavity and is fixed with a third bevel gear. A fourth bevel gear is meshed with one end surface of the third bevel gear. The fourth bevel gear is fixedly connected, and a pressure groove is communicated between the pushing groove and the open cavity. A pressure rod with an upper end abutting the solid block is slidably arranged in the pressure groove, and the pressure rod is connected with the pressure block. The push blocks are rotationally connected by a connecting rod, and a compression spring is fixed between the pressure rod and the pressure groove; four of the pressure rods are simultaneously lowered, so that the cleaning wheel moves into the cavity, It rotates to scrub the mouse pad.

In a further technical solution, the power device includes a connecting groove communicating with the pushing groove, and a transmission gear is arranged in the connecting groove through a rotating shaft, and the rotating shafts are respectively connected by a connecting belt for power connection. A connecting cavity is provided on one side of the connecting groove, and the rotating shaft extends into the connecting cavity and a fifth bevel gear is fixedly connected to the front end of the fifth bevel gear. A sixth bevel gear is meshed with the first bevel gear. The mandrel of the six-bevel gear is connected to the transmission shaft (with the cavity as the center line) on the same side through a belt, and a motor is fixed in the rear wall of the cavity, and power is connected to the two ends of the motor. A shaft, the power shaft and the said rotating shaft are respectively connected by a transmission belt power; the motor works, so that the four transmission gears rotate.

The beneficial effects of the present invention are: the structure of the present invention is simple, the operation is convenient, and the mouse pad is cleaned by soaking, scrubbing, washing, and drying processes. In this process, the degree of automation is high, labor is saved, and cleaning time is shortened. The cleaned mouse pad can be used directly, which is convenient and efficient.

### BRIEF DESCRIPTION OF THE DRAWINGS

FIG. 1 is a schematic diagram of the overall internal structure of a cleaning device for a mouse pad according to the present invention;

FIG. 2 is an enlarged structural diagram of “A” in FIG. 1 in the present invention;

FIG. 3 is a schematic structural view in the direction of “B-B” in FIG. 1 in the present invention;

FIG. 4 is an enlarged structural diagram of “C” in FIG. 3 in the present invention; FIG.

FIG. 5 is a schematic diagram of the structure in the direction of “D-D” in FIG. 3 in the present invention.

### DETAILED DESCRIPTION OF THE INVENTION

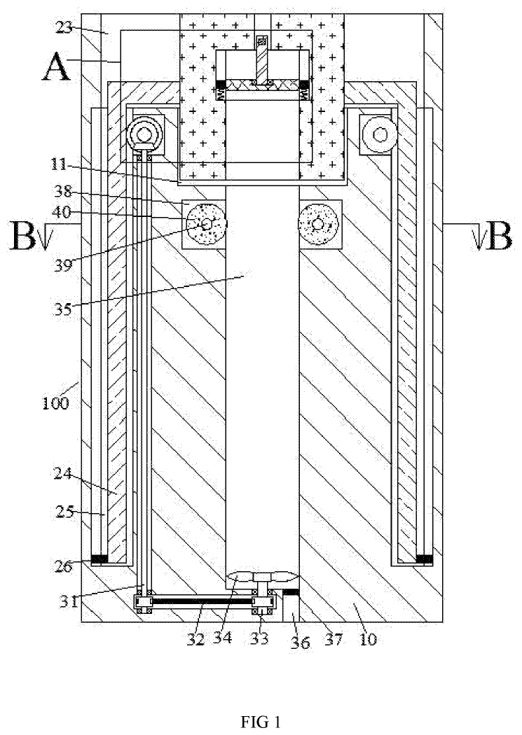

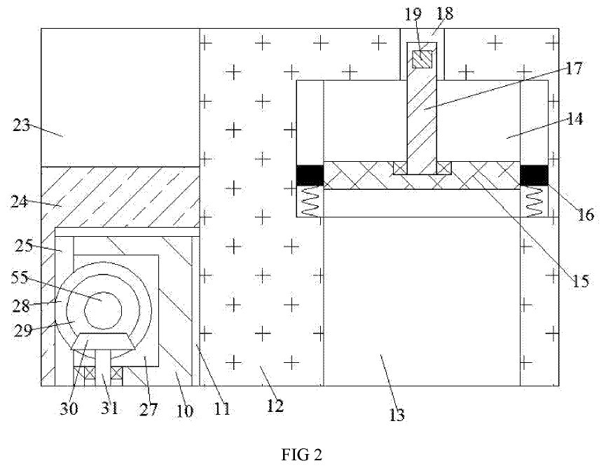

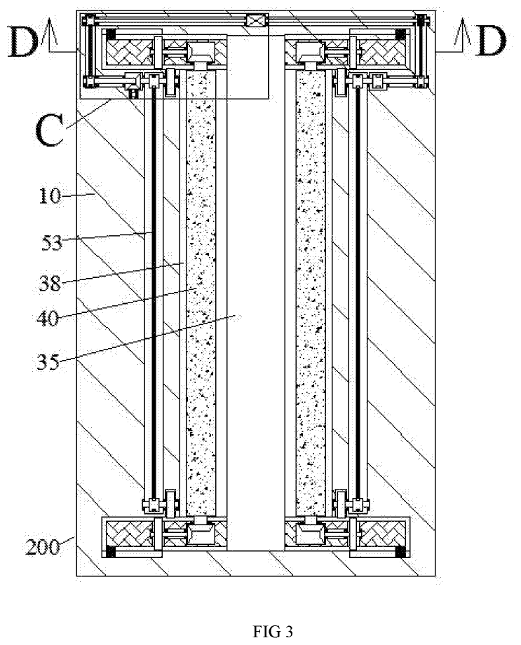

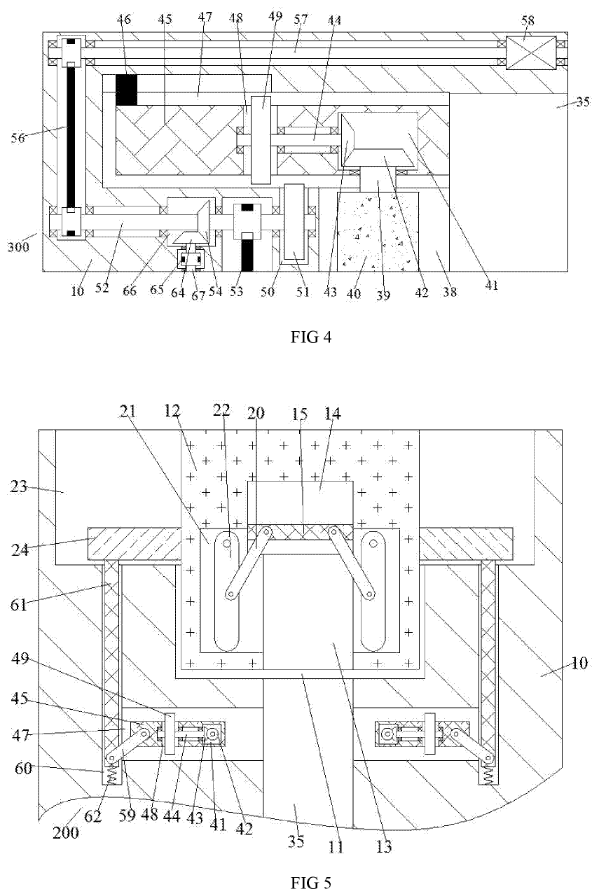

The present invention will be described in detail below with reference to FIGS. 1-5. For convenience of description, the orientation described below is defined as follows: the up-down, front-back, left-right direction described below is consistent with the up-down, front-back, left-right direction of the projection relationship of FIG. 1 itself.

Referring to FIGS. 1-5, a cleaning device for a mouse pad according to an embodiment of the present invention includes a body 10, which is provided with a slot 11 with an opening facing upward, and a clip is inserted into the slot 11. Block 12, the clamping block 12 is provided with a clamping groove 13, and the upper side of the clamping groove 13 is provided with a sliding groove 14, and a sliding plate 15 is slidably arranged in the sliding groove 14, and the left and right ends of the sliding plate 15 are fixedly installed. A reset assembly 16 for resetting the slide plate 15 is provided with a pull rod 17 on the upper end surface of the slide plate 15; a through groove 18 is provided on the upper side of the slide groove 14 to communicate with the outside; A fixed rod 19 that enters the external space is provided with a rotating rod 20 at four corners of the lower end surface of the sliding plate 15, a clamping groove 21 is provided at the four corners of the clamping groove 13, and a clamping rod 22 is provided in the rotating groove 21, The clamping rod 22 is rotatably connected to the lower end of the rotating rod 20, and an open cavity 23 is provided on both sides of the slot 11. A fixed block 24 fixedly connected to the clamping block 12 is slidably arranged in the open cavity 23. The open cavity 23 The lower side communicates with a sliding cavity 25. The lower end of the solid block 24 extends into the sliding cavity 25. One end of the solid block 24 is fixed with a slider 26. The sliding cavity 25 communicates with one side. There is a meshing cavity 27. A rotation gear 28 is provided in the meshing cavity 27 through a transmission shaft 55 for rotation. A cavity 35 is provided on the lower side of the slot 11, and a rotation shaft 33 is provided in the cavity 35 for rotation. The upper end of the rotating shaft 33 is uniformly provided with three fan blades 34. A transmission device 100 is provided on the left side of the cavity 35. The transmission device 100 is dynamically connected to the rotating shaft 33. A water tank is provided on the lower side of the cavity 35. 36, a solenoid valve 37 is fixed in the water tank 36, and a shrinking groove 38 is provided on both sides of the cavity 35. A soft shaft for cleaning the surface of the mouse pad is provided in the shrinking groove 38 through a fixed shaft 39. The cleaning wheel 40, the cavity 35 is provided with a cleaning device 200 symmetrically on the left and right sides, and the cleaning device 200 is respectively fixedly connected to the front and rear ends of the fixing shaft 39 on the same side; the clamping rod 22 is used to clamp a mouse pad, The mouse pad is driven up by the solid block 24, and the cleaning pad 40 is rotated to clean the mouse pad.

Advantageously, the transmission device 100 includes a first bevel gear 29 fixed on the front end of the transmission shaft 55 on the left side, and the first bevel gear 29 is rotatably provided in the meshing cavity 27 on the left side through the gear shaft 31. 29 meshing second bevel gear 30, the lower end of the gear shaft 31 and the rotating shaft 33 are dynamically connected by a toothed belt 32; the first bevel gear 29 drives the fan blade 34 to rotate, agitating the cavity 35 cleaning solution or generate wind to dry the mouse pad.

Advantageously, the cleaning device 200 includes a pushing groove 47 which is symmetrical in the front-rear direction and communicates with the shrinking groove 38. A pushing block 45 is slidably arranged in the pushing groove 47, and a guide block 46 is fixed on the rear end surface of the pushing block 45. The push slot 47 is provided with a slot 48 therein. The slot 48 is provided with a meshing gear 49 through a coupling shaft 44. A power unit 300 is provided between the push slot 47. The meshing gear 49 meshes, a transmission cavity 41 is provided on one side of the slot 48, and one end of the coupling shaft 44 extends into the transmission cavity 41 and a third bevel gear 43 is fixedly attached to the third bevel gear. A fourth bevel gear 42 is meshedly connected to one end surface, the front and rear ends of the fixed shaft 39 are respectively fixedly connected to the fourth bevel gear 42, and a pressure groove 60 is provided between the pushing groove 47 and the opening cavity 23. A pressing rod 61 having an upper end abutting against the solid block 24 is slidably provided in the pressing groove 60. The pressing rod 61 and the pushing block 45 are rotatably connected through a connecting rod 59. A pressure spring 62 is fixed between the pressure grooves 60; the four pressure levers 61 are synchronously lowered, so that the cleaning wheel 40 moves into the cavity 35, and the mouse pad is scrubbed by its rotation.

Beneficially, the power device 300 includes a connecting groove 50 communicating with the pushing groove 47. A transmission gear 51 is rotatably provided in the connecting groove 50 through a rotating shaft 52, and a connecting belt 53 is connected between the rotating shafts 52. For power connection, a connecting cavity 66 is provided on one side of the connecting groove 50 on the rear side. The rotating shaft 52 extends into the connecting cavity 66 and a fifth bevel gear 54 is fixedly attached to the fifth bevel gear 54. The front end is meshed with a sixth bevel gear 64, and a mandrel 67 of the sixth bevel gear 64 is dynamically connected to the transmission shaft 55 (with the cavity 35 as a center line) on the same side through a belt 65, and the cavity A motor 58 is fixed in the rear wall of the motor 35, and a power shaft 57 is dynamically connected at both ends of the motor 58. The power shaft 57 and the rotation shaft 52 are respectively power-connected through a transmission belt 56; the motor 58 works, Four of the transmission gears 51 are caused to rotate.

In the initial state, the cleaning wheel 40 is located in the shrinking groove 38, the meshing gear 49 is not meshed with the transmission gear 51, the solid block 24 is in contact with the pressing rod 61, and the compression spring 62 is in a compressed state.

When the device is required to work, the motor 58 rotates forward to drive the power shaft 57 to rotate, the rotation shaft 52 rotates, and the rotation gear 28 rotates through the belt 65. The solid block 24 rises to drive the clamp block 12 to rise. Then, the upper end of the mouse pad is raised. Placed in the clamping groove 13 and pulling up the fixing rod 19 to drive the slide plate 15 upward, the left and right clamping rods 22 are rotated toward each other by the rotating rod 20 to clamp the upper end of the mouse pad forward and backward, and the lower end surface of the fixing rod 19 and the upper end surface of the body 10 The abutment fixes 15 and fills the cavity 35 with clean water. The motor 58 is reversed. The clamp block 12 is lowered and connected to the slot 11. The mouse pad is immersed in the cavity 35. After soaking, the motor 58 is rotated forward. Then, the clamp block 12 drives the mouse pad to rise, and the pressure lever 61 rises under the action of the compression spring 62, so that the push block 45 moves in the direction of the cavity 35, and the left and right cleaning wheels 40 move toward the mouse pad, and the gear is engaged at this time. 49 meshes with the transmission gear 51, so that the cleaning wheel 40 rotates and scrubs the mouse pad from top to bottom. Thereafter, the solenoid valve 37 is opened to drain the cleaning water in the cavity 35, and the cavity 35 is filled with clean water. Water, cleaning liquid for mouse pad, washing, To drain water from the cavity 35, the working machine 58, via a toothed belt 32 so that the blade 34 rotates, the wind mouse pad dried.

The beneficial effects of the present invention are: the structure of the present invention is simple, the operation is convenient, and the mouse pad is cleaned by soaking, scrubbing, washing, and drying processes. In this process, the degree of automation is high, labor is saved, and cleaning time is shortened. The cleaned mouse pad can be used directly, which is convenient and efficient.

Those skilled in the art can clearly understand that various modifications to the above embodiments can be made without departing from the overall spirit and concept of the present invention. They all fall within the protection scope of the present invention. The protection scheme of the present invention is subject to the claims attached to the present invention.

1. A cleaning device for a mouse pad, comprising a machine body, the machine body is provided with a slot with an opening facing upward, a clip block is inserted into the slot, and a clip slot is provided in the clip block, and the clip The upper side of the groove is provided with a slide groove, and a slide plate is slidably arranged in the slide groove. The left and right ends of the slide plate are fixed with resetting components for resetting the slide plate. The upper end surface of the slide plate is provided with a pull rod. The upper side of the groove communicates with the outside. A through groove is fixed on the upper end of the pull rod. A fixed rod extending into the external space is fixed on the upper end of the pull rod. Rotating rods are provided at the four corners of the lower end of the slide plate. A clamping rod is rotatably provided in the rotating slot, and the clamping rod is rotatably connected to the lower end of the rotating rod. Two sides of the slot are provided with an opening cavity. The opening cavity is slidably provided with a clamping rod. A solid block, a sliding cavity is provided on the lower side of the open cavity, the lower end of the solid block extends into the sliding cavity, a slider is fixed on one end of the solid block, and an engaging cavity is provided on one side of the sliding cavity. A rotating gear is provided in the engaging cavity through a transmission shaft for rotation, and a cavity is provided on the lower side of the slot. A rotating shaft is provided for rotation in the cavity, and three fan blades are evenly arranged on the upper end of the rotating shaft. A transmission device is provided on the left side of the cavity, and the transmission device is dynamically connected with the rotating shaft. There is a water tank, a solenoid valve is fixed in the water tank, a shrink groove is provided on both sides of the cavity, and a soft cleaning wheel for cleaning the surface of the mouse pad is provided in the shrink groove through a fixed shaft. A cleaning device is symmetrically arranged on the left and right sides of the cavity, and the cleaning device is respectively fixedly connected to the front and rear ends of the fixed shaft on the same side; the clamping rod is used to clamp the mouse pad, and the mouse pad is raised by the fixed block, and The cleaning wheel is rotated to clean the mouse pad.

2. The cleaning device for a mouse pad according to claim 1, wherein the transmission device comprises a first bevel gear fixed at the front end of the transmission shaft on the left side, and in the engagement cavity on the left side. A second bevel gear meshing with the first bevel gear is provided through the rotation of the gear shaft, and the lower end of the gear shaft and the rotating shaft are dynamically connected by a toothed belt; the first bevel gear drives the fan blade to rotate, Agitate the cleaning solution in the cavity or generate wind to dry the mouse pad.

3. The cleaning device for a mouse pad according to claim 1, wherein the cleaning device comprises a pushing groove which is symmetrical in front and back and communicates with the shrinking groove, and a pushing block is slidably arranged in the pushing groove, A guide block is fixed on the rear end surface of the pushing block, and a slot is provided in the pushing slot. A meshing gear is provided in the slot through a coupling shaft to rotate, and a power device is provided between the pushing slots. The device meshes with the meshing gear, a transmission cavity is communicated with the slotted side, one end of the coupling shaft extends into the transmission cavity and a third bevel gear is fixed, and one end surface of the third bevel gear meshes A fourth bevel gear is connected, the front and rear ends of the fixed shaft are respectively fixedly connected to the fourth bevel gear, a pressure groove is provided between the pushing groove and the opening cavity, and an upper end and a sliding groove are provided in the pressure groove. Pressure rods abutting the fixed blocks, the pressure rods and the push blocks are rotationally connected by a connecting rod, and pressure springs are fixed between the pressure rods and the pressure grooves; four of the pressure rods Synchronous descending makes the cleaning wheel move into the cavity and rotates to scrub the mouse pad.

4. The cleaning device for a mouse pad according to claim 3, wherein the power device includes a connecting groove communicating with the pushing groove, and a transmission gear is provided in the connecting groove through a rotation shaft, The rotating shafts are respectively connected by a connecting belt for power connection. A connecting cavity is provided on the back side of the connecting groove. The rotating shaft extends into the connecting cavity and a fifth bevel gear is fixed. The front end of the fifth bevel gear is meshed with a sixth bevel gear. The mandrel of the sixth bevel gear is power-connected to the transmission shaft (with the cavity as the center line) on the same side through a belt. A motor is fixed in the wall, and a power shaft is dynamically connected at both ends of the motor, and the power shaft and the rotation shaft are respectively power-connected through a transmission belt; the motor works to make four of the transmission gears rotate.
